(19) United States
(12) Patent Application Publication
(10) Pub. No.: US 2022/0281444 A1
(43) Pub. Date: Sep. 8, 2022

(54) VEHICLE PATH GENERATION METHOD, VEHICLE PATH GENERATION DEVICE, VEHICLE, AND PROGRAM

(71) Applicant: MITSUBISHI HEAVY INDUSTRIES, LTD., Tokyo (JP)

(72) Inventors: Kazushige TAKAKI, Tokyo (JP); Yasuo FUJISHIMA, Tokyo (JP); Ryoji ARAKI, Tokyo (JP); Kenji TAKAO, Tokyo (JP)

(21) Appl. No.: 17/679,378

(22) Filed: Feb. 24, 2022

(30) Foreign Application Priority Data
Mar. 4, 2021 (JP) 2021-034388

(51) Int. Cl. B60W 30/09

(52) U.S. Cl. CPC B60W 30/09; B60W 2530/201; B60W 2554/801; B60W 2554/802; B60W 2520/10; B60W 2520/06

(57) ABSTRACT

A path generation method includes: acquiring information about a position of a vehicle; acquiring information about a target position of the vehicle; acquiring information about a position of an obstacle; setting a constraint condition that the vehicle at each of predicted steps does not interfere with the obstacle, based on the position of the vehicle, a size of the vehicle and the position of the obstacle; and calculating a moving path of the vehicle by optimization calculation based on the constraint condition and an evaluation function in which a score becomes higher as a deviation between the position of the vehicle at each of the predicted steps and the target position becomes smaller.

### CROSS-REFERENCE TO RELATED APPLICATIONS

This application claims the benefit of priority to Japanese Patent Application Number 2021-034388 filed on Mar. 4, 2021. The entire contents of the above-identified application are hereby incorporated by reference.

### TECHNICAL FIELD

The present disclosure relates to a vehicle path generation method, a vehicle path generation device, a vehicle, and a program.

### RELATED ART

In order to move a vehicle to a target position, a moving path of the vehicle is set. Such a vehicle is required to reach the target position while avoiding an obstacle. For example, JP 2020-004095 A describes that a path is generated so as to avoid a moving obstacle.

### SUMMARY

However, there is room for improvement in path setting in order for a vehicle to reach a target position while avoiding an obstacle, and it is necessary to appropriately set a path that enables avoidance of an obstacle.

The present disclosure has been made to solve the above-described problem, and an object thereof is to provide a vehicle path generation method, a vehicle path generation device, a vehicle, and a program that enable appropriate setting of a path that enables obstacle avoidance.

In order to solve the above problem and achieve the above object, a vehicle path generation method according to the present disclosure includes: acquiring information about a position of a vehicle; acquiring information about a target position of the vehicle, acquiring information about a position of an obstacle; setting a constraint condition that the vehicle at each of predicted steps does not cause interference with the obstacle, based on the position of the vehicle, a size of the vehicle and the position of the obstacle; and calculating a moving path of the vehicle by optimization calculation based on the constraint condition and an evaluation function in which a score becomes higher as the deviation between the position of the vehicle at each of the predicted steps and the target position becomes smaller.

In order to solve the above problem and achieve the above object, a vehicle path generation device according to the present disclosure includes: a self-position information acquisition unit configured to acquire information about a position of a vehicle; a target position information acquisition unit configured to acquire information about a target position of the vehicle; an obstacle information acquisition unit configured to acquire information about a position of an obstacle; and a calculation execution unit. The calculation execution unit sets a constraint condition that the vehicle at each of predicted steps does not interfere with the obstacle based on the position of the vehicle, a size of the vehicle and the position of the obstacle, and calculates a moving path of the vehicle by optimization calculation based on the constraint condition and an evaluation function in which a score becomes higher as the deviation between the position of the vehicle at each of the predicted steps and the target position becomes smaller.

In order to solve the above problem and achieve the object, a vehicle according to the present disclosure includes the vehicle path generation device.

In order to solve the above problem and achieve the above object, a program according to the present disclosure causes a computer to execute: acquiring information about a position of a vehicle; acquiring information about a target position of the vehicle; acquiring information about a position of an obstacle; setting a constraint condition that the vehicle at each of predicted steps does not interfere with the obstacle, based on the position of the vehicle, a size of the vehicle and the position of the obstacle; and calculating a moving path of the vehicle by optimization calculation based on the constraint condition and an evaluation function in which a score becomes higher as the deviation between the position of the vehicle at each of the predicted steps and the target position becomes smaller.

According to the present disclosure, it is possible to appropriately set a path that enables avoidance of an obstacle.

### BRIEF DESCRIPTION OF DRAWINGS

The disclosure will be described with reference to the accompanying drawings, wherein like numbers reference like elements.

FIG. 1 is a schematic view of a vehicle control system according to a first embodiment.

FIG. 2 is a schematic block diagram of a management system.

FIG. 3 is a schematic block diagram of a vehicle according to a first embodiment.

FIG. 4 is a schematic block diagram of a control unit according to a first embodiment.

FIG. 5 is a schematic view for describing a constraint condition.

FIG. 6 is a flowchart for describing a processing flow of a control device according to the present embodiment.

FIG. 7 is a schematic view for describing another example of a constraint condition.

### DESCRIPTION OF EMBODIMENTS

Preferred embodiments of the present disclosure will be described in detail below with reference to the accompanying drawings. Note that the present disclosure is not limited to these embodiments, and, when there are a plurality of embodiments, the present disclosure is intended to include a configuration combining these embodiments.

### First Embodiment

### Control System

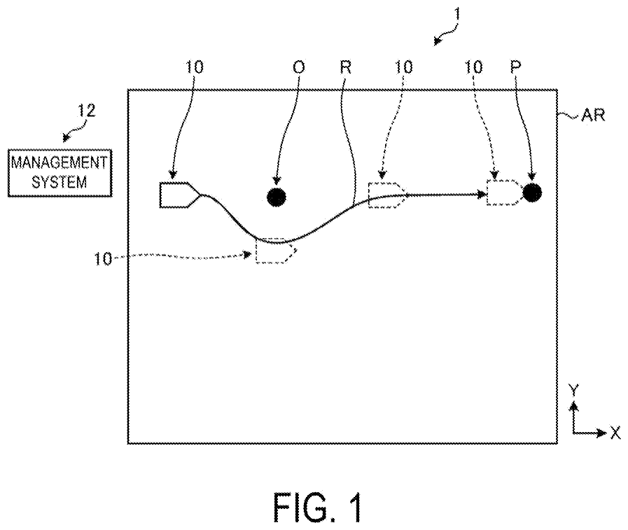

FIG. 1 is a schematic view of a vehicle control system according to a first embodiment. As illustrated in FIG. 1, a control system 1 according to the first embodiment includes a vehicle 10 and a management system 12. The vehicle 10 is a mobile body capable of moving automatically, but is not limited thereto, and may be a manned mobile body operated by a driver. The vehicle 10 may be a mobile body traveling on the ground, a mobile body flying in the air, or a mobile body moving in water. Thus, the vehicle 10 also includes a mobile body capable of moving in three dimensions, but for the sake of explanation, a case where the vehicle 10 moves on a two-dimensional plane will be described below. Examples of the vehicle 10 that moves on a two-dimensional plane include an automated guided forklift (AGF), an automated guided vehicle (AGV), and the like, but the type of the vehicle 10 may be arbitrary. Hereinafter, a region in which the vehicle 10 can move, that is, a region in which the vehicle 10 is scheduled to move is referred to as an area AR. The area AR is a two-dimensional plane in the present embodiment, and a direction along the horizontal direction is an X direction, and a direction along the horizontal direction and orthogonal to the X direction is a Y direction. Note that the area AR may be a three-dimensional space.

In the present embodiment, the vehicle 10 moves along a moving path R. The moving path R is set so as to enable the vehicle 10 to move toward a target position P while avoiding an obstacle O present in the area AR. The obstacle O is an object to be avoided by the vehicle 10. In the present embodiment, the obstacle O may be any object whose position may change, or any object that may exist at a certain timing but may not exist at another timing. In other words, the obstacle O in the present embodiment is not a structure permanently fixed in a known position. Note that the obstacle O is not limited to a non-living object, and may be, for example, a living object including human beings. A method of setting the moving path R will be described later.

### Management System

The management system 12 is a system that manages the vehicle 10 and sets the target position P of the vehicle 10 in the present embodiment. The management system 12 is a warehouse management system (WMS) in the present embodiment, but is not limited to WMS, and may be any system such as a so-called ground system, for example.

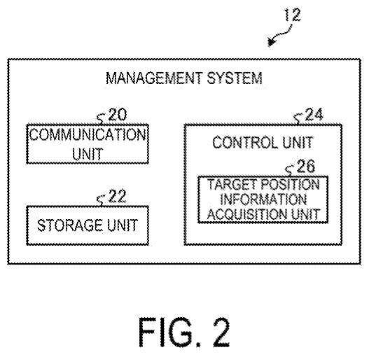

FIG. 2 is a schematic block diagram of the management system. The management system 12 is a computer, and as illustrated in FIG. 2, includes a communication unit 20, a storage unit 22, and a control unit 24. The communication unit 20 is a communication module that communicates with an external device such as the vehicle 10, and is, for example, an antenna. The management system 12 performs wireless communication, but any communication method may be used. The storage unit 22 is a memory that stores various information such as computation content of the control unit 24 and programs, and includes, for example, at least one of a primary storage device such as a random access memory (RAM) or a read only memory (ROM), and an external storage device such as a hard disk drive (HDD). The program stored in the storage unit 22 for the control unit 24 may be stored in a recording medium that is readable by the management system 12.

The control unit 24 is an arithmetic device and includes an arithmetic circuit such as a central processing unit (CPU), for example. The control unit 24 includes a target position information acquisition unit 26. The control unit 24 reads a program (software) from the storage unit 22 and executes the program to implement the target position information acquisition unit 26 and perform processing of the target position information acquisition unit 26. Note that the control unit 24 may execute such processing with a single CPU, or may include a plurality of CPUs and execute the processing with the plurality of CPUs. The target position information acquisition unit 26 may be implemented by a hardware circuit.

The target position information acquisition unit 26 acquires the position information of the target position P of the vehicle 10. The target position information acquisition unit 26 sets, for example, work content to be performed by the vehicle 10 and sets the target position P in accordance with the work content. However, the method of acquiring the position information of the target position P by the target position information acquisition unit 26 is arbitrary, and may be specified by a user, for example. The target position information acquisition unit 26 transmits the position information of the target position P of the vehicle 10 to the vehicle 10 via the communication unit 20.

Note that the management system 12 is not an essential component, and for example, the vehicle 10 may set the target position P.

### Vehicle

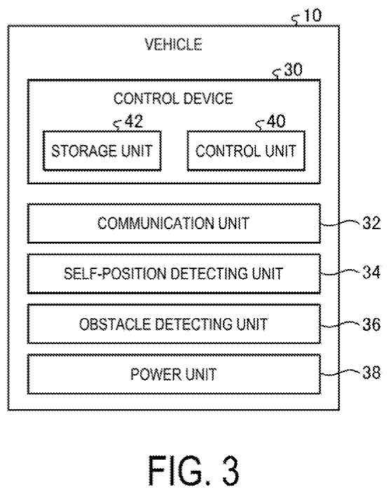

FIG. 3 is a schematic block diagram of the vehicle according to the first embodiment. As illustrated in FIG. 3, the vehicle 10 includes a control device 30, a communication unit 32, a self-position detecting unit 34, an obstacle detecting unit 36, and a power unit 38.

### Communication Unit

The communication unit 32 is a communication module that communicates with an external device, and is, for example, an antenna. The vehicle 10 performs wireless communication, but any communication method may be used. In the present embodiment, the vehicle 10 communicates with the management system 12 via the communication unit 32 to transmit and receive information.

### Self-Position Detecting Unit

The self-position detecting unit 34 is a device that detects the position and orientation of the vehicle 10, that is, the self-position and the self-orientation of the vehicle 10. In the present embodiment, the position of the vehicle 10 refers to the coordinates of a position in the area AR at which the vehicle 10 is located. The orientation of the vehicle 10 refers to a direction in which the vehicle 10 is oriented, and in the present embodiment, refers to the orientation of the vehicle 10 (rotation angle) when viewed from a direction orthogonal to the direction X and the direction Y. Hereinafter, unless otherwise noted, “position” and “orientation” have the same meanings as described above. The self-position detecting unit 34 may detect a position and an orientation by an arbitrary method. Examples of the specific configuration of the self-position detecting unit 34 include a positioning device that detects a position by using a positioning system such as a global positioning system (GPS). For example, the self-position detecting unit 34 may be an inertial navigation system that detects a position with respect to a predetermined starting point. Further, for example, the self-position detecting unit 34 may detect a position and an orientation by a laser beam. In that case, for example, the self-position detecting unit 34 can detect a position and an orientation by irradiating a reflector provided in the area AR with a light beam and detecting the light beam reflected from the reflector.

### Obstacle Detecting Unit

The obstacle detecting unit 36 is a sensor that detects the position and orientation of the obstacle O. The obstacle detecting unit 36 may be any sensor as long as it can detect the position and orientation of the obstacle O, and may be a sensor using, for example, 2D-Light Detection And Ranging (LiDAR), 3D-LiDAR, a camera, or the like.

### Power Unit

The power unit 38 functions as a power source for moving the vehicle 10, The specific configuration of the power unit 38 depends on an operational mode of the vehicle 10. As an example, in the case where the vehicle 10 is a vehicle that travels on the ground, the power unit 38 includes a plurality of wheels and a prime mover that drives all or some of the plurality of wheels. The specific configuration of the power unit 38 illustrated here is merely an example and is not limited thereto. The power unit 38 may function as a power source that enables the vehicle 10 to move.

### Control Device

The control device 30 is a device that controls the movement of the vehicle 10. The control device 30 is a computer, and includes a control unit 40 and a storage unit 42. The storage unit 42 is a memory for storing various information such as computation content of the control unit 40 and programs, and includes, for example, at least one of a primary storage device such as a RAM or a ROM, and an external storage device such as an HDD. The program stored in the storage unit 42 for the control unit 40 may be stored in a recording medium that is readable by the control device 30.

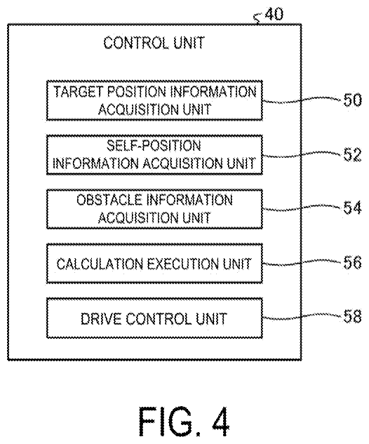

FIG. 4 is a schematic block diagram of the control unit according to a first embodiment. The control unit 40 is an arithmetic device and includes an arithmetic circuit such as a CPU, for example. As illustrated in FIG. 4, the control unit 40 includes a target position information acquisition unit 50, a self-position information acquisition unit 52, an obstacle information acquisition unit 54, a calculation execution unit 56, and a drive control unit 58. The control unit 40 reads a program (software) from the storage unit 42 and executes it to implement the target position information acquisition unit 50, the self-position information acquisition unit 52, the obstacle information acquisition unit 54, the calculation execution unit 56 and the drive control unit 58, and executes the processing of those units. Note that the control unit 40 may execute such processing with a single CPU, or may include a plurality of CPUs and execute the processing with the plurality of CPUs. At least some of the target position information acquisition unit 50, the self-position information acquisition unit 52, the obstacle information acquisition unit 54, the calculation execution unit 56 and the drive control unit 58 may be implemented by a hardware circuit.

### Target Position Information Acquisition Unit

The target position information acquisition unit 50 acquires the position information of the target position P which is the target destination of the vehicle 10, The target position information acquisition unit 50 acquires the position information of the target position P from the management system 12 via the communication unit 32. However, the target position information acquisition unit 50 is not limited to acquiring the position information of the target position P from the management system 12, and may set the target position P by itself.

Self-Position information Acquisition Unit

The self-position information acquisition unit 52 acquires information about the position and orientation of the vehicle 10 itself. The self-position information acquisition unit 52 controls the self-position detecting unit 34 to acquire position information (coordinate information) and orientation information (orientation information) of the vehicle 10 itself. Hereinafter, position information and orientation information are appropriately described as position and orientation information. The self-position information acquisition unit 52 sequentially acquires the position and orientation information of the vehicle 10 at predetermined time intervals. However, the self-position information acquisition unit 52 is not limited to detecting the position and orientation of the vehicle 10 by itself. For example, an external device such as the management system 12 may detect the position and orientation of the vehicle 10, and the self-position information acquisition unit 52 may acquire the detection result as the position and orientation information of the vehicle 10.

### Obstacle Information Acquisition Unit

The obstacle information acquisition unit 54 acquires the information about the position of the obstacle O. The obstacle information acquisition unit 54 controls the obstacle detecting unit 36 to acquire the position information of the obstacle O. The obstacle information acquisition unit 54 sequentially acquires the position information of the obstacle O at predetermined time intervals. However, the obstacle information acquisition unit 54 is not limited to detecting the position of the obstacle O by itself. For example, an external device such as the management system 12 may detect the position of the obstacle O, and the obstacle information acquisition unit 54 may acquire the detection result from the management system 12 as the position information of the obstacle O. Note that the obstacle information acquisition unit 54 may acquire the orientation of the obstacle O in addition to the position of the obstacle O.

### Calculation Execution Unit

The calculation execution unit 56 performs optimization calculation to calculate a drive condition of the vehicle 10 that can realize an optimized moving path R of the vehicle 10. The drive condition refers to an input value for operating the power unit 38 of the vehicle 10. In the present embodiment, in order to perform the optimization calculation, the calculation execution unit 56 sets a constraint condition that the position of the vehicle 10 at each of predicted steps does not interfere with the obstacle O. Each of the predicted steps refers to a discrete time after the present time (the timing when the position of the obstacle O and the position and orientation of the vehicle 10 were most recently detected). Then, the calculation execution unit 56 performs the optimization calculation based on the constraint condition and an evaluation function in which a score becomes higher as the deviation between the position of the vehicle 10 at each of the predicted steps and the target position P becomes smaller, and calculates the drive condition of the vehicle 10 that can realize the moving path R of the vehicle 10 optimized through the optimization calculation. Hereinafter, the optimization calculation by the calculation execution unit 56 will be described in detail. In the following description, the movement of the vehicle 10 on a two-dimensional coordinate plane in the X direction and the Y direction will be described as an example. However, the description is also applicable to a kinematic model on three-dimensional coordinates.

### Vehicle Position at Each of Predicted Steps

Here, the optimized moving path R calculated by the calculation execution unit 56 can be considered as a set of the position and orientation of the vehicle 10 at each of the predicted steps (each discrete time after the present time), and can be said to be a future path. Assuming that the position (coordinates) of the vehicle 10 in the X direction and the Y direction is [x, y]^{T}, the orientation of the vehicle 10 is θ, and the predicted step (discrete time) is k, the position and orientation of the vehicle 10 at the predicted step k, that is, the moving path R at the predicted step k is represented by Equation (1) below.

Note that T stands for transpose. Note that, as described above, the description of the present embodiment is an example of the movement on two-dimensional plane coordinates, and for example, in the case of a kinematic model on three-dimensional coordinates, the following equations and the like are adapted to the three-dimensional coordinates.

Equation 1

p(k)=[x(k)y(k)θ(k)]^{T} (1)

In this case, the kinematic model of the vehicle 10 is represented as in Equation (2):

Equation 2

p(k+1)=f(p(k),u(k),Δt) (2)

At in Equation (2) is the time width related to the transition from (k) to (k+1). Δt may be equal to an update cycle of the moving path R (a time width from an update of the moving path R to the next update of the moving path R), but may be shorter than the update cycle, or may be longer than the update cycle, for example. By making Δt shorter than the update cycle, it is possible to generate a detailed moving path R and reduce a calculation load. Further, u(k) is a system input and refers to the drive condition of the vehicle 10. In the example of the present embodiment, u(k) is represented as in Equation (3) below, using a velocity v(k) of the vehicle 10 and a steering angle Φ(k) of the vehicle 10.

Equation 3

u(k)=[v(k)ϕ(k)]^{T} (3)

Assuming a movement on two-dimensional plane coordinates, a system state equation f is represented as in Equation (4) below, for example. Here. L refers to a wheel base which is, for example, a distance between a front wheel and a rear wheel.

$$\begin{matrix}Equation 4 & \\ f ( p ( k ) , u ( k ) , Δ t ) = [ \begin{matrix}x ( k ) + Δ t \cdot v ( k ) \cdot cos θ ( k ) \\ y ( k ) + Δ t \cdot v ( k ) \cdot sin θ ( k ) \\ θ ( k ) + Δ t \cdot \frac{v ( k )}{L} \cdot tan ϕ ( k )\end{matrix} ] & ( 4 )\end{matrix}$$

### Constraint Condition

The calculation execution unit 56 sets a constraint condition used for the optimization calculation. The calculation execution unit 56 sets the vehicle 10 at each of the predicted steps to not interfere with the obstacle O, based on the position of the vehicle 10, the size of the vehicle 10 and the position of the obstacle O as the constraint condition. That is, the constraint condition in the present embodiment is set such that, at each of the predicted steps, the vehicle 10 of that size does not interfere with the obstacle O. Note that, in the example of the present embodiment, the size of the vehicle 10 is a width and a length of the vehicle 10 (lengths in the X direction and the Y direction). The size of the vehicle 10 is stored in advance in the storage unit 42 or the like as design information, for example, and the calculation execution unit 56 reads the information about the size of the vehicle 10 from the storage unit 42. However, the calculation execution unit 56 may acquire the information about the size of the vehicle 10 in any manner.

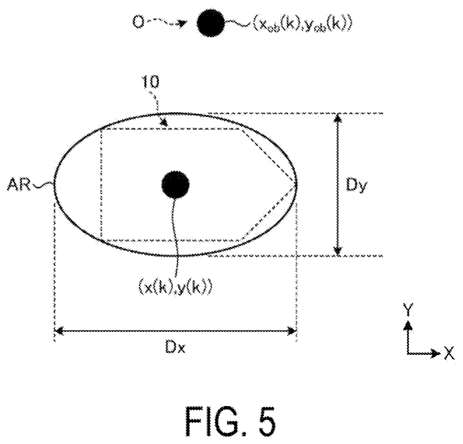

FIG. 5 is a schematic view for describing a constraint condition. A method of setting a constraint condition will be described in more detail. As illustrated in FIG. 5, the calculation execution unit 56 sets the vehicle area AR that is a region including a position of the vehicle 10 at an predicted step, based on the size of the vehicle 10. The calculation execution unit 56 sets a region obtained by expanding a position of the vehicle 10 at an predicted step by an area corresponding to the size of the vehicle 10 as the vehicle area AR. Then, the calculation execution unit 56 sets the position of the obstacle O to be out of the range of the vehicle area AR at each of predicted steps as the constraint condition. That is, the calculation execution unit 56 sets the vehicle area AR at each of predicted steps, and sets the position of the obstacle O to be out of the range of the vehicle area AR at each of the predicted steps as the constraint condition. In the example in FIG. 5, an elliptical region centered around the position [x(k), y(k)] of the vehicle 10 with the length Dx in the X direction of the vehicle 10 as a major radius and the length Dy in the Y direction of the vehicle 10 as a minor radius is set as the vehicle area AR.

However, the method of setting the vehicle area. AR is not limited thereto, and the vehicle area AR need not be elliptical, for example.

In the present embodiment, the calculation execution unit 56 temporarily sets the position and orientation of the vehicle 10 at each of predicted steps when setting a constraint condition. Then, the calculation execution unit 56 calculates the position (coordinates) of the obstacle O in the coordinate system of the vehicle 10 at each of predicted steps. That is, the calculation execution unit 56 converts the position (coordinates) of the obstacle O in the coordinate system in the X direction and the Y direction acquired by the obstacle information acquisition unit 54 into a position (coordinates) with the position of the vehicle 10 at an predicted step as a coordinate center. For example, the calculation execution unit 56 uses equation (5) below to calculate the position of the obstacle O in the coordinate system of the vehicle 10.

$$\begin{matrix}Equation 5 & \\ [ \begin{matrix}{x}_{ob} ( k ) \\ {y}_{ob} ( k )\end{matrix} ] = [ \begin{matrix}cos ( θ ( k ) ) & sin ( θ ( k ) ) \\ - sin ( θ ( k ) ) & cos ( θ ( k ) )\end{matrix} ] [ \begin{matrix}{x}_{ob}^{′} - x ( k ) \\ {y}_{ob}^{′} - y ( k )\end{matrix} ] & ( 5 )\end{matrix}$$

Note that [x′_{ob},y′_{ob}] is the position of the obstacle O in the coordinate system in the X direction and Y direction acquired by the obstacle information acquisition unit 54, and [x_{ob}(k),y_{ob}(k)]^{T} is the position of the obstacle O in the coordinate system of the vehicle 10 at an predicted step k.

Then, the calculation execution unit 56 sets Equation (6) below as a constraint condition. Equation (6) is an equation indicating that the position of the obstacle O is out of the range of the vehicle area AR having an elliptical shape at each of the predicted steps. However, Equation (6) is an example of an equation of a constraint condition in the case where the vehicle area AR has an elliptical shape, and an equation of the actual constraint condition is set depending on the shape and the size of the vehicle area AR.

$$\begin{matrix}Equation 6 & \\ {( \frac{{x}_{ob} ( k )}{\frac{{D}_{x}}{2}} )}^{2} + {( \frac{{y}_{ob} ( k )}{\frac{{D}_{y}}{2}} )}^{2} > 1 & ( 6 )\end{matrix}$$

Note that, the reason why a constraint condition can be solved at each of the predicted steps in this manner is that the position and orientation of the vehicle 10 at each of the predicted steps are temporarily set through predictive calculation thereof based on a kinematic model.

### Optimization Calculation

The calculation execution unit 56 performs optimization calculation based on the constraint condition set as described above and an evaluation function in which a score becomes higher as the deviation between the position of the vehicle 10 at each of the predicted steps and the target position P becomes smaller. That is, the calculation execution unit 56 predicts (predicts) a moving path that satisfies the constraint condition using the concept of model predictive control, evaluates the deviation between the vehicle 10 and the target position P with respect to the position of the vehicle 10 at each predicted step using an evaluation function in which a score becomes higher as a distance in the relationship between the vehicle 10 at each of the predicted steps and the target position P becomes shorter, and then determines the moving path R. This enables the calculation execution unit 56 to determine the optimized moving path R, that is, the optimized position and orientation of the vehicle 10 at each of the predicted steps. In other words, the calculation execution unit 56 determines the optimized position and orientation (that is, the optimized moving path R) of the vehicle 10 which satisfies the constraint condition that the position of the vehicle 10 at each of the predicted steps does not interfere with the obstacle O, and in which the deviation between the position of the vehicle 10 at each of predicted steps and the target position P is minimized.

In the present embodiment, it is assumed that a problem V (u,p,k) for optimizing the moving path R is represented by Equation (7) below.

$$\begin{matrix}Equation 7 & \\ V ( u , p , k ) = {min}_{u} {\sum }_{k} J ( u , p , k ) & ( 7 )\end{matrix}$$

Here, J(u,p,k) is an evaluation function representing the objective of optimization, and is set as a function that includes approaching or reaching a target position in the case of path planning. In the example of the present embodiment, the calculation execution unit 56 sets the evaluation function J(u,p,k) as in Equation (8) below.

Equation 8

J(u,p,k)=A₁(x(k)−x_{T})²+A₂(y(k)−y_{T})²+A₃(θ(k)−θ_{T})² (8)

Here, pᵣ=[x(k),y(k),θ(k)]^{T}, that is, xᵣ, yᵣ, and θᵣ in Equation (8) are the target position and orientation.

A₁, A₂, and A₃ are weighting factors and may be set arbitrarily. Under this evaluation function, the deviation between the position and orientation (p(k)) of the vehicle 10 at each of the predicted steps and the target position and orientation (pᵣ) is optimized so that it is minimized. That is, the optimization result is such that the vehicle 10 approaches the target position and orientation at the shortest distance.

By executing the optimization calculation as described above, the calculation execution unit 56 obtains a value of u(k) which is a drive condition (system input) for each of the predicted steps, as an output (optimal solution) of the optimization calculation. The drive condition for each of the predicted steps obtained by the calculation execution unit 56 can be said to be a drive condition that realizes the optimized moving path R. The calculation execution unit 56 may calculate the optimized moving path R based on the drive condition for each of the predicted steps obtained by the optimization calculation. For example, the calculation execution unit 56 may calculate the optimized moving path R by substituting u(k) obtained by the optimization calculation into Equation (2).

As a method of solving an optimization problem, a nonlinear optimization method such as sequential quadratic programming may be used, for example. The optimization method used here needs to be able to solve an optimization problem on which a constraint condition is imposed. Note that, for example, in the case where Equation (2) or a constraint condition is a non-linear function, it is preferable to use a nonlinear optimization method, and a linear optimization method may not be suitable.

### Drive Control Unit

The drive control unit 58 controls the vehicle 10 based on the drive condition acquired by the calculation execution unit 56. The drive control unit 58 drives the power unit 38 under the drive condition acquired by the calculation execution unit 56. Accordingly, the drive control unit 58 moves the vehicle 10 along the optimized moving path R.

In the above description, the calculation execution unit 56 calculates a drive condition for each of the predicted steps as an output for realizing the optimized moving path R by performing the optimization calculation, but is not limited thereto. For example, the calculation execution unit 56 may perform the optimization calculation to calculate the optimized moving path R. In that case, the calculation execution unit 56 may calculate a drive condition for each of the predicted steps based on the optimized moving path R. Further, the calculation execution unit 56 of the control device 30 calculates the moving path R, and another device or program may acquire the information about the moving path R from the control device 30 and calculate a drive condition. That is, the control device 30 can be said to be a path generation device configured to set the moving path R.

### Processing Flow

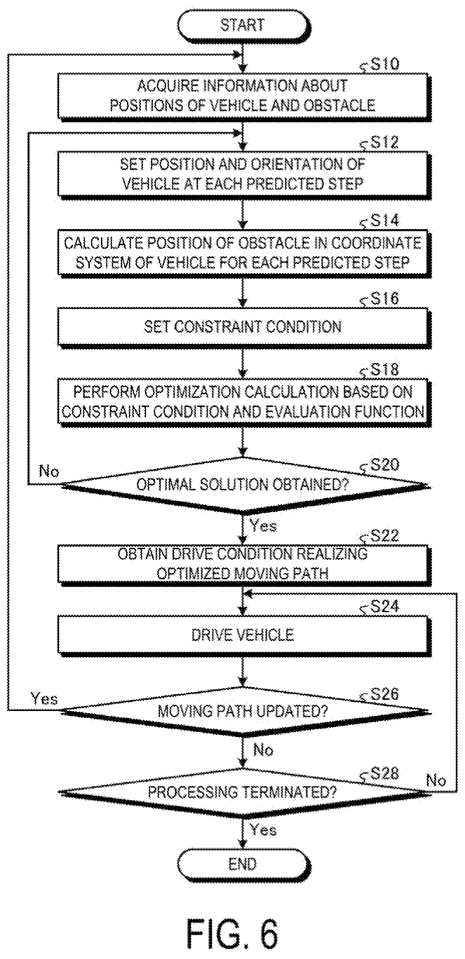

Next, a processing flow according to the present embodiment will be described. FIG. 6 is a flowchart for describing a processing flow of the control device according to the present embodiment. When setting the moving path R, the control device 30 acquires the position information of the target position P through the target position information acquisition unit 50. Further, the control device 30 acquires the position and orientation information of the vehicle 10 and the position information of the obstacle O through the self-position information acquisition unit 52 and the obstacle information acquisition unit 54 (step S10). Subsequently, the controller 30 temporarily sets the position and orientation of the vehicle 10 at each of predicted steps based on the position and orientation information of the vehicle 10 and the position information of the target position P through the calculation execution unit 56 (step S12). Then, the calculation execution unit 56 sets a constraint condition that the obstacle O and the vehicle 10 do not interfere with each other (step S16) based on the position and orientation of the vehicle 10 at each of the predicted steps, the size of the vehicle 10 and the position information of the obstacle O, and performs optimization calculation based on the set constraint condition and an evaluation function (step S18). When no optimal solution can be obtained (step S20; No), the processing returns to step S12 to set again the position and orientation of the vehicle 10 and repeat calculation until an optimal solution is obtained. When an optimal solution is obtained as a result of the optimization calculation (step 20; Yes), the calculation execution unit 56 acquires, as the optimal solution, the drive condition that can realize the optimized moving path R. The drive control unit 58 controls the vehicle 10 based on the acquired drive condition (step S24) to move the vehicle 10 along the moving path R. Then, in the case of updating the moving path R (step S26 Yes), that is, for example when the update period is reached, the processing returns to step S10, the latest positions of the vehicle 10 and the obstacle O are acquired, and the subsequent processing is repeated based on the latest positions to update the moving path R. When the moving path R is not updated (step S26; No), and when the processing is not terminated (step S28; No), the processing returns to step S24 and the movement on the current moving path R is continued. If the processing is to be terminated (step S28; Yes), the processing is terminated.

### Effect

As described above, in the present embodiment, because the moving path R is set using the optimization calculation, it is possible to appropriately set a constraint condition for avoiding the obstacle O using an equation or the like, and it is possible to appropriately set the moving path R that can avoid the obstacle O while heading toward the target position. Further, in the present embodiment, a constraint condition is set also in consideration of the size of the vehicle 10. For example, the constraint condition is that the obstacle O is set out of the range of the vehicle area AR. Accordingly, it is possible to appropriately set a path that enables avoidance of the obstacle O. Moreover, because the size of the vehicle 10 can also be reflected in a predicted position of the vehicle 10, it is not necessary to set an excessively large area of occupancy prohibited from overlapping with the obstacle O (here, the vehicle area AR). In addition, by using an evaluation function that reduces a deviation from a target, it is possible to generate the shortest path that enables avoidance of the obstacle O. Note that, a method of imposing a constraint condition on optimization calculation is not limited to the method described above, and, for example, a constraint may be incorporated into an objective function V(u,p,k) or an evaluation function J(u,p,k). Besides, in the above description, although the case where there is a single obstacle O is described as an example, there may be a plurality of obstacles O.

In addition, in the present embodiment, because the moving path R is set using optimization calculation, it is possible to generate a feasible moving path R by taking into account the kinematics of the actual vehicle 10. For example, in the case of a vehicle with a non-holonomic kinematic constraint condition imposed that cannot move in a lateral direction, it is possible to generate the moving path R in consideration of such a kinematic constraint. The condition for such a kinematic constraint condition can be incorporated into Equation (2), for example.

In the present embodiment, the vehicle 10 includes the control device 30, and the control device 30 included in the vehicle 10 performs the process of setting the moving path R such as optimization calculation. However, the process of setting the moving path R such as optimization calculation is not limited to being performed by the vehicle 10, and may be performed by an external device such as the management system 12. In that case, the vehicle 10 may acquire the drive condition and the moving path R obtained by optimization calculation from an external device, and control the vehicle 10 (power unit 38) using the drive condition and the moving path R acquired. In other words, the control device 30 may be included in the vehicle 10 or may be included in a device other than the vehicle 10. Moreover, the functions of the target position information acquisition unit 50, the self-position information acquisition unit 52, the obstacle information acquisition unit 54, and the calculation execution unit 56 may be included in the vehicle 10 or may be included in other devices.

### Other Examples of Constraint Conditions

Other examples of constraint conditions used for optimization calculation will be described below. Also in the following examples, the moving path R may be calculated to obtain a drive condition as an output, or a drive condition that can realize the optimized moving path R may be calculated.

### Consideration of Spatial Displacement of Obstacle

For example, the calculation execution unit 56 may set a constraint condition that the position of the vehicle 10 at each of predicted steps does not interfere with the obstacle O based on a spatial displacement Δd of the obstacle O. Here, the spatial displacement Ad refers to a distance over which the obstacle O is expected to move. In this case, the calculation execution unit 56 acquires the information about the spatial displacement Ad over which the obstacle O will move during a period from the present time (the timing when the position of the obstacle O is acquired) to a timing of the predicted step, and sets the position of the vehicle 10 to not interfere with the obstacle O even when the obstacle O moves over the spatial displacement Ad as the constraint condition. For example, the calculation execution unit 56 may calculate the spatial displacement Δd using Equation (9) below.

Equation 9

Δd=v_{ob}·Δt (9)

Here, v_{ob} is the velocity of the obstacle O. v_{ob} may be obtained by any method. For example, v_{ob} may be set in advance or may be detected by the calculation execution unit 56. When detecting v_{ob}, the calculation execution unit 56 may acquire a value detected by a velocimeter, or may perform calculation based on the position of the vehicle 10 at each timing acquired by the self-position information acquisition unit 52.

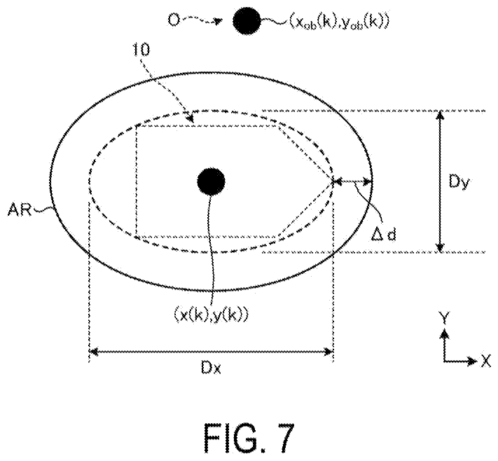

FIG. 7 is a schematic view for describing another example of a constraint condition. In the present example, the calculation execution unit 56 sets a region obtained by expanding the position of the vehicle 10 at an predicted step by an area corresponding to the size of the vehicle 10 and the spatial displacement Δd as the vehicle area AR. Then, the calculation execution unit 56 sets the position of the obstacle O to be out of the range of the vehicle area AR at each of predicted steps as the constraint condition. Consequently, it is possible to prevent the obstacle O from interfering with the vehicle 10 even when the obstacle O moves.

### Consideration of Size of Obstacle

For example, the calculation execution unit 56 may set a constraint condition that the position of the vehicle 10 at each of the predicted steps does not interfere with the obstacle O based on the size of the obstacle O. In that case, the calculation execution unit 56 acquires the information about the size of the obstacle O, and sets the vehicle 10 to not interfere with the obstacle O of that size as the constraint condition. Note that, in the example of the present embodiment, the size of the obstacle O is the width and length of the obstacle O (lengths in the X direction and the Y direction). The calculation execution unit 56 may acquire the size of obstacle O by any method. For example, the calculation execution unit 56 may calculate the size of obstacle O based on the detection result of the obstacle detecting unit 36, or may acquire the information about the size of the obstacle O set in advance.

In the present example, the calculation execution unit 56 sets a region obtained by expanding the position of the vehicle 10 at an predicted step by an area corresponding to the size of the vehicle 10 and the size of the obstacle O as the vehicle area AR. Then, the calculation execution unit 56 sets the position of the obstacle O to be out of the range of the vehicle area AR at each of the predicted steps as the constraint condition. Consequently, it is possible to more suitably prevent the obstacle O from interfering with the vehicle 10. Note that the calculation execution unit 56 may incorporate both of the spatial displacement Δd of the obstacle O and the size of the obstacle O into a constraint condition. In that case, for example, the calculation execution unit 56 sets a region obtained by expanding the position of the vehicle 10 at an predicted step by an area corresponding to the size of the vehicle 10, the size of the obstacle O and the spatial displacement Ad of the obstacle O as the vehicle area AR.

### Consideration of Drive Condition

For example, the calculation execution unit 56 may also set a constraint condition that a drive condition is within a predetermined range. That is, the calculation execution unit 56 sets the upper and lower limit values of system inputs such as movement velocity and steering angle that depend on the performance or the operational condition of the vehicle 10. Accordingly, it is possible to appropriately generate a moving path R that is feasible for the vehicle 10. For example, the calculation execution unit 56 may set a drive condition to be within a predetermined range as the constraint condition, as in Equation (10) below:

Equation 10

uₘᵢₙ<u(k)<uₘₐₓ (10)

Here, uₘᵢₙ is the lower limit value of a drive condition, uₘₐₓ is the upper limit value of a drive condition, and each of them may be arbitrarily set based on the performance or operational condition of the vehicle 10, or the like.

In addition, the calculation execution unit 56 may also further set a variation in a drive condition per unit time to be within a predetermined range as the constraint condition. That is, the calculation execution unit 56 sets the upper and lower limit values of the time rate of a variation in a system input such as movement acceleration and steering angular acceleration that depend on the performance or operational condition of the vehicle 10, or the like, and generates a feasible moving path R. For example, the calculation execution unit 56 may set a drive condition to be within a predetermined range as a constraint condition, as in Equation (11) below:

$$\begin{matrix}Equation 11 & \\ {a}_{min} < \frac{u ( k + 1 ) - u ( k )}{Δ t} < {a}_{max} & ( 11 )\end{matrix}$$

Here, aₘᵢₙ is the lower limit value of a variation in a drive condition per unit time, aₘₐₓ is the upper limit value of a variation in a drive condition per unit time, and each may be arbitrarily set based on the performance or operational condition of the vehicle 10, or the like. In addition, for example, the term {u(k+1)−u(k)/Δt}; in equation (11) may be a square value or an absolute value.

### Consideration of Vehicle Position

For example, the calculation execution unit 56 may also further set the position and orientation of the vehicle 10 at an predicted step to be within a predetermined range as a constraint condition. That is, the calculation execution unit 56 grasps in advance a region where the vehicle 10 cannot enter, such as an area where there is a structure whose position is known in advance, and sets a constraint condition so that the vehicle 10 is located within a range where the vehicle 10 can enter. Accordingly, it is possible to appropriately generate a moving path R that is feasible for the vehicle 10. For example, the calculation execution unit 56 may set a constraint condition that the position and orientation of the vehicle 10 are within a predetermined range, as in Equation (12) below.

Equation 12

pₘᵢₙ<p(k)<pₘₐₓ (12)

Here, pₘᵢₙ is the lower limit value of the position and orientation of the vehicle 10, pₘₐₓ is the upper limit value of the position and orientation of the vehicle 10, and each may be arbitrarily se based on the position of a structure, or the like. Here, the position and orientation of the vehicle 10 are set within a predetermined range as the constraint condition, but the constraint is not limited to being imposed on both the position and orientation of the vehicle 10, and may be set such that at least one of the position and orientation of the vehicle 10 is within a predetermined range.

### Second Embodiment

Next, a second embodiment will be described. In the first embodiment, the drive condition is set as the velocity and steering angle of the vehicle 10. However, the second embodiment is different from the first embodiment in that the drive condition is set as the velocity and turning curvature of the vehicle 10. In the second embodiment, the description of parts having the same configuration as those in the first embodiment will be omitted. Also in the second embodiment, the moving path R may be calculated to obtain a drive condition as an output, or a drive condition that can realize an optimized moving path R may be calculated.

In the second embodiment, the calculation execution unit 56 sets the velocity of the vehicle 10 and the turning curvature of the vehicle 10 as system inputs, that is, the drive condition. The turning curvature refers to the reciprocal of a radius (radius of curvature) of a circle drawn by the vehicle 10 under the assumption that the vehicle 10 moves at the current steering angle. For example, a turning curvature c(k) at an predicted step k is defined as in Equation (13) below:

$$\begin{matrix}Equation 13 & \\ c ( k ) = \frac{1}{L} \cdot tan ϕ ( k ) & ( 13 )\end{matrix}$$

In the first embodiment, the kinematic model of the vehicle 10 is represented as in Equation (2) because the velocity and steering angle of the vehicle 10 are set as the drive condition. However, when the velocity and turning curvature of the vehicle 10 are set as the drive condition as in the second embodiment, the kinematic model of the vehicle 10 is represented as in Equation (14) below, for example,

$$\begin{matrix}Equation 14 & \\ f ( p ( k ) , u ( k ) , Δ t ) = [ \begin{matrix}x ( k ) + Δ t \cdot v ( k ) \cdot cos θ ( k ) \\ y ( k ) + Δ t \cdot v ( k ) \cdot sin θ ( k ) \\ θ ( k ) + Δ t \cdot v ( k ) \cdot c ( k )\end{matrix} ] & ( 14 )\end{matrix}$$

Also in the second embodiment, the calculation execution unit 56 performs the optimization calculation by the same method as in the first embodiment except that a drive condition is changed to the velocity and turning curvature of the vehicle 10, so as to obtain the optimal solution for a drive condition. However, the optimal solution for a drive condition in the second embodiment is obtained as the velocity and turning curvature of the vehicle 10. The calculation execution unit 56 may substitute a turning curvature obtained as an optimal solution into, for example, Equation (13), to calculate a steering angle, and may control the vehicle 10 using the steering angle as a drive condition.

Even in the case where a turning curvature is used as a drive condition as in the second embodiment, it is possible to impose the constraint condition on the drive condition. In that case, for example, a limit value may be set to the turning curvature itself, or a limit value may be set by converting the turning curvature into a steering angle as in Equation (15) below. Here, cₘₐₓ is the limit value of a turning curvature, and Φₘₐₓ is the limit value of a steering angle.

$$\begin{matrix}Equation 15 & \\ {c}_{max} = \frac{1}{L} \cdot tan {ϕ}_{max} & ( 15 )\end{matrix}$$

As in the second embodiment, because the trigonometric function tan Φ can be eliminated from the optimization calculation by using a turning curvature as the drive condition, it is possible to reduce a calculation load.

### Effects of the Present Disclosure

As described above, the path generation method of the vehicle 10 according to the present disclosure includes: acquiring information about the position of the vehicle 10; acquiring information about the target position P of the vehicle 10; acquiring information about the position of the obstacle O; setting a constraint condition that the vehicle 10 at each of the predicted steps does not interfere with the obstacle O, based on the position of the vehicle 10, the size of the vehicle 10 and the position of the obstacle O; and calculating the moving path R of the vehicle 10 by optimization calculation based on the constraint condition and an evaluation function in which a score becomes higher as the deviation between the position of the vehicle 10 at each of the predicted steps and the target position P becomes smaller. According to the present method, because the constraint condition is set in consideration of the size of the vehicle 10 and the moving path R is set by using optimization calculation, it is possible to appropriately set a path that enables avoidance of the obstacle O. Moreover, because the size of the vehicle 10 can also be reflected in a predicted position of the vehicle 10, it is not necessary to set an excessively large area of occupancy prohibited from overlapping with the obstacle O (here, the vehicle area AR).

In the step of setting the constraint condition, the vehicle area AR that is a region including a position of the vehicle 10 at an predicted step is set based on the size of the vehicle 10, and the position of the obstacle O is set to be out of the range of the vehicle area AR at each of the predicted steps as the constraint condition. According to the present method, by using the vehicle area AR as the constraint condition in this manner, it is possible to appropriately set a path that enables avoidance of the obstacle O.

In the step of setting the constraint condition, the vehicle area is also set based on the spatial displacement of the obstacle O. By also including the spatial displacement of the obstacle O in the vehicle area AR in this manner, it is possible to appropriately set a path that enables avoidance of the obstacle O.

In the step of setting the constraint condition, the vehicle area is also set based on the size of the obstacle O. By also including the size of the obstacle O in the vehicle area AR in this manner, it is possible to appropriately set a path that enables avoidance of the obstacle O.

In the step of setting the constraint condition, the drive condition of the vehicle 10 is further set within a predetermined range as the constraint condition. By also imposing the constraint condition on the drive condition in this manner, it is possible to appropriately generate a moving path R that is feasible for the vehicle 10.

In the step of setting the constraint condition, the position of the vehicle 10 at an predicted step is further set within a predetermined range as the constraint condition. By also imposing a constraint on the position of the vehicle 10 in this manner, it is possible to appropriately generate a moving path R that is feasible for the vehicle 10.

The present path generation method further includes a step of calculating the drive condition of the vehicle 10 based on a moving path R of the vehicle 10. This makes it possible to calculate the drive condition of the vehicle 10 that can realize an optimized moving path R, and to appropriately, control the vehicle 10.

The present path generation method may set the velocity and steering angle of the vehicle 10 as the drive condition of the vehicle 10. By performing optimization calculation using the velocity and steering angle of the vehicle 10 as a drive condition, it is possible to obtain the velocity and steering angle also as outputs, and control the vehicle 10 appropriately.

The present path generation method may set the velocity and turning curvature of the vehicle 10 as the drive condition of the vehicle 10. By performing optimization calculation using the turning curvature of the vehicle 10 as a drive condition, it is possible to reduce the calculation load of the optimization calculation and shorten processing time.

The present path generation method includes a step of controlling the vehicle 10 based on the set drive condition of the vehicle 10. According to the present path generation method, the vehicle 10 can appropriately avoid the obstacle O.

The control device 30 (path generation device) according to the present disclosure includes the self-position information acquisition unit 52 that acquires the information about the position of the vehicle 10, the target position information acquisition unit 50 that acquires the information about the target position P of the vehicle 10, the obstacle information acquisition unit 54 that acquires the information about the position of the obstacle O, and the calculation execution unit 56. The calculation execution unit 56 sets a constraint condition that the vehicle 10 at each of predicted steps does not interfere with the obstacle O, based on the position of the vehicle 10, the size of the vehicle 10 and the position of the obstacle O. Then, the calculation execution unit 56 performs optimization calculation based on the constraint condition and an evaluation function in which a score becomes higher as the deviation between the position of the vehicle 10 at each of the predicted steps and the target position P becomes smaller, and calculates the moving path R of the vehicle 10. According to the control device 30, it is possible to appropriately set a path that enables avoidance of the obstacle O.

The vehicle 10 according to the present disclosure includes the controller 30. The vehicle 10 can avoid the obstacle O.

The program according to the present disclosure causes a computer to execute: acquiring the information about the position of the vehicle 10; acquiring the information about the target position P of the vehicle 10; acquiring the information about the position of the obstacle O; setting a constraint condition that the vehicle 10 at each of predicted steps does not interfere with the obstacle O, based on the position of the vehicle 10, the size of the vehicle 10 and the position of the obstacle O; and calculating the moving path R of the vehicle 10 by optimization calculation based on the constraint and an evaluation function in which a score becomes higher as the deviation between the position of the vehicle 10 at each of the predicted steps and the target position P becomes smaller. According to the present program, it is possible to appropriately set a path that enables avoidance of the obstacle O.

The embodiment of the present disclosure is described above, but the embodiment is not limited by the details of the embodiment above. Further, the constituent elements of the above-described embodiment include elements that are able to be easily conceived by a person skilled in the art, and elements that are substantially the same, that is, elements of an equivalent scope. Furthermore, the constituent elements described above can be appropriately combined. Further, it is possible to make various omissions, substitutions, and changes to the constituent elements within a range not departing from the scope of the above-described embodiment.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A vehicle path generation method comprising:
acquiring information about a position of a vehicle;
acquiring information about a target position of the vehicle;
acquiring information about a position of an obstacle;
setting a constraint condition that the vehicle at each of predicted steps does not interfere with the obstacle, based on the position of the vehicle, a size of the vehicle and the position of the obstacle; and
calculating a moving path of the vehicle by optimization calculation based on the constraint condition and an evaluation function in which a score becomes higher as a deviation between the position of the vehicle at each of the predicted steps and the target position becomes smaller.

2. The vehicle path generation method according to claim 1, wherein, in the setting of the constraint condition, a vehicle area that is a region including the position of the vehicle at an predicted step, of the predicted steps, is set based on the size of the vehicle, and the position of the obstacle is set to be out of a range of the vehicle area at each of the predicted steps as the constraint condition.

3. The vehicle path generation method according to claim 2, wherein, in the setting of the constraint condition, the vehicle area is also set based on a spatial displacement of the obstacle.

4. The vehicle path generation method according to claim 2, wherein, in the setting of the constraint condition, the vehicle area is also set based on a size of the obstacle.

5. The vehicle path generation method according to claim 1, wherein, in the setting of the constraint condition, a drive condition of the vehicle is further set to be within a predetermined range as the constraint condition.

6. The vehicle path generation method according to claim 1, wherein, in the setting of the constraint condition, the position of the vehicle at each of the predicted steps is further set to be within a predetermined range as the constraint condition.

7. The vehicle path generation method according to claim 1, further comprising:
calculating the drive condition of t vehicle based on the moving path of the vehicle.

8. The vehicle path generation method according to claim 7, wherein a velocity and a steering angle of the vehicle are set as the drive condition of the vehicle.

9. The vehicle path generation method according to claim 7, wherein the velocity and a turning curvature of the vehicle are set as the drive condition of the vehicle.

10. The vehicle path generation method according to claim 7, further comprising;
controlling the vehicle based on the drive condition of the vehicle set.

11. A vehicle path generation device comprising:
a self-position information acquisition unit configured to acquire information about a position of a vehicle;
a target position information acquisition unit configured to acquire information about a target position of the vehicle;
an obstacle information acquisition unit configured to acquire information about a position of an obstacle; and
a calculation execution unit,
the calculation execution unit being configured to
set a constraint condition that the vehicle at each of predicted steps does not interfere with the obstacle based on the position of the vehicle, a size of the vehicle and the position of the obstacle, and
calculate a moving path of the vehicle by optimization calculation based on the constraint condition and an evaluation function in which a score becomes higher as a deviation between the position of the vehicle at each of the predicted steps and the target position becomes smaller.

12. A vehicle comprising the vehicle path generation device according to claim 11.

13. A non-transitory computer readable storage medium storing a program for causing a computer to execute processing, the processing comprising:
acquiring information about a position of a vehicle;
acquiring information about a target position of the vehicle;
acquiring information about a position of an obstacle;
setting a constraint condition that the vehicle at each of predicted steps does not interfere with the obstacle, based on the position of the vehicle, a size of the vehicle and the position of the obstacle; and
calculating a moving path of the vehicle by optimization calculation based on the constraint condition and an evaluation function in which a score becomes higher as a deviation between the position of the vehicle at each of the predicted steps and the target position becomes smaller.
